(19) United States
(12) Patent Application Publication
(10) Pub. No.: US 2010/0265801 A1
(43) Pub. Date: Oct. 21, 2010

(54) TIMING SYSTEM AND METHOD OF TIMING

(75) Inventors: Mathias Marten Ernest Ehelen, Upper Hutt (NZ); Arthur Roberts, Porirua (NZ); Warren Young, Whangaparaoa (NZ); Neil Thackery, Lower Hutt (NZ)

Correspondence Address: MERCHANT & GOULD PC, P.O. BOX 2903, MINNEAPOLIS, MN, 55402-0903, US

(73) Assignee: TIMES-7 HOLDINGS LIMITED

(21) Appl. No.: 12/669,551

(22) PCT Filed: Jul. 17, 2008
(86) PCT No.: PCT/NZ08/00170

§ 371 Date: Jun. 25, 2010

(30) Foreign Application Priority Data
Jul. 18, 2007 (NZ) 556603

(51) Int. Cl. G04F 10/00

(52) U.S. Cl. 368/9

(57) ABSTRACT

A timing system which illuminates an elongate timing region so that RFID transponders illuminated in the region transmit identification signals that are used to generate timing information associated with competitors. A panel antenna is preferably provided on the ground to create the elongate timing region and the system preferably operates at UHF. The RFID tag preferably uses a notch antenna and may be incorporated into a credit card.

### FIELD OF THE INVENTION

This invention relates to a timing system and to a method of timing that is suitable for timing a wide variety of sports events.

### BACKGROUND OF THE INVENTION

A wide range of electronic sports timing systems are known in the art, Example systems utilise low frequency RFID, high frequency RFID, dual frequency RFID, and photo finishes.

Examples of commercially available high frequency timing systems include Dag Systems, Championchip, Winning Time, AMB Chip X, and Chronolec RCS. An example of a dual frequency timing system is from iPico Sports, which uses HF and low frequency RFID. Once optimised, these systems tend to perform well with slow to medium speed competitors (40 km/h maximum), which makes them unsuitable for most cycling events, and for motor sports. These systems typically utilise large ground mats measuring several metres—allowing the competitor to be detected any time when they are over the mat—which permits a detection uncertainty (or maximum error) of well over a metre, in addition to other system timing uncertainties.

Some commercially available high frequency (HF) timing systems use active or battery powered tags to increase the reading range of the tags, and thereby, to operate with faster moving objects. This significantly increases the cost of the tag, and thereby the cost of the total system. To make the system easier to use, some active tags are wired to receive battery power from the host vehicle—where this is possible. Alternatively, battery replacement or recharging is required. Examples include AMB Tranx Pro, and Chronolec Elite.

A further form of sports timing that is known in the art is the technique of high speed photographic finishes, which is especially well suited for the determination of the relative placement of competitors. These systems are expensive, and are intrinsically unsuitable for mass participation events (e.g. 1,000+ competitors starting an event at the same time).

Also known in the art is RFID using ultra high frequency (UHF) electromagnetic radiation. UHF based RFID has the advantage over HF RFID in that the reading range is significantly longer, making it well suited for wide area applications such as warehouse inventory control and pallet tracking. The directionality (or shape) of RF fields is also able to be more accurately controlled with higher frequencies, allowing the potential for more accurate timing of the detection of the competitor. In the art, passive, active, semi-active (or battery assisted), and active RFID techniques are known. UHF RFID has not previously been applied to sports timing applications due to the difficulties of RF obstruction and interference from human bodies and other objects such as bicycles.

It would be desirable to provide a timing system and method of timing that allowed for greater accuracy of timing than the HF timing systems presently available whilst also retaining the ability to cater for mass participation events. It would also be desirable to provide a timing system and method of timing that allowed reliable detection of competitors or objects traveling at higher speeds (e.g. 65 km/h for competitive cycling, or 200 km/h for motor sports), whilst retaining the cost advantages of passive RFID, or semi-active RFID, or which at least provides the public with a useful choice.

### EXEMPLARY EMBODIMENTS

According to one exemplary embodiment there is provided a timing system comprising:
a. a radio frequency signal source;
b. a transmitting antenna driven by the radio frequency signal source configured to illuminate an elongate timing region;
c. a receiving antenna for receiving signals generated by RFID transponders illuminated by the transmission antenna; and
d. a timing circuit which generates timing information based on the signals received by the receiving antenna.

The transmitting antenna and the receiving antenna may be separate antennas, or the same antenna may be used for both functions with suitable attached RF components.

According to another exemplary embodiment there is provided a method of timing articles passing through an elongate timing region comprising:
a. securing an RFID tag with a unique identifier to each article;
b. illuminating the timing region with a first beam;
c. receiving signals transmitted from the RFID tags as they pass through the timing region; and
d. associating timing information with each RFID tag identifier based on the received signals.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention.

FIG. 1 shows a schematic diagram of a timing system according to one embodiment;

FIG. 2 shows an antenna configuration according to one embodiment;

FIG. 3 shows an antenna configuration according to another embodiment;

FIG. 4 and FIG. 5 show an exemplary method of interlocking the ground based antennas;

FIGS. 6a and 6b show ground mounted antennas covered with waterproof mats;

FIG. 7 shows a plan view of an antenna array of the type shown in FIG. 2 indicating the coverage area of the propagated field;

FIGS. 8a to 8d show a preferred sequence of antenna switching, whereby every second panel antenna is switched in an alternating pattern with the other antennas;

FIGS. 9a to 9d show an alternative sequence of antenna switching, whereby every second panel antenna is attenuated in an alternating pattern with the other antennas;

FIG. 10 shows an RFID tag mounted on a bicycle;

FIG. 11 shows an exemplary RFID tag, packaged in the form of a credit card;

FIG. 12 shows an exemplary panel antenna suitable for mounting on the ground; and

FIG. 13 shows a variant of the panel antenna of FIG. 12.

### DETAILED DESCRIPTION OF EMBODIMENTS OF THE INVENTION

The sports timing system 1 described provides a system for timing sports events such as bicycle races, marathons, and triathlons. It is able to time the start of the race (often with thousands of competitors), the finish of the race (often with competitors at speeds of 65 km/h), and also to provide split times at designated mid points in the race at which the system may be deployed.

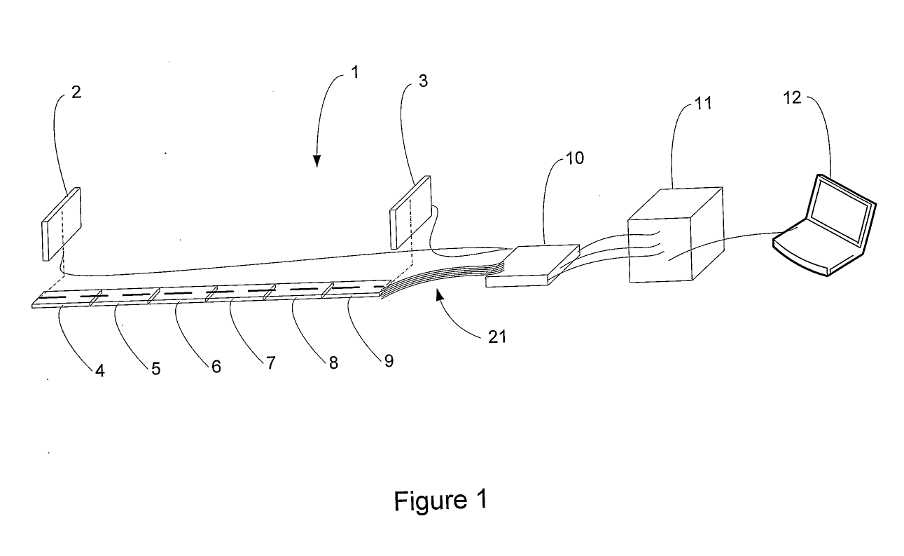

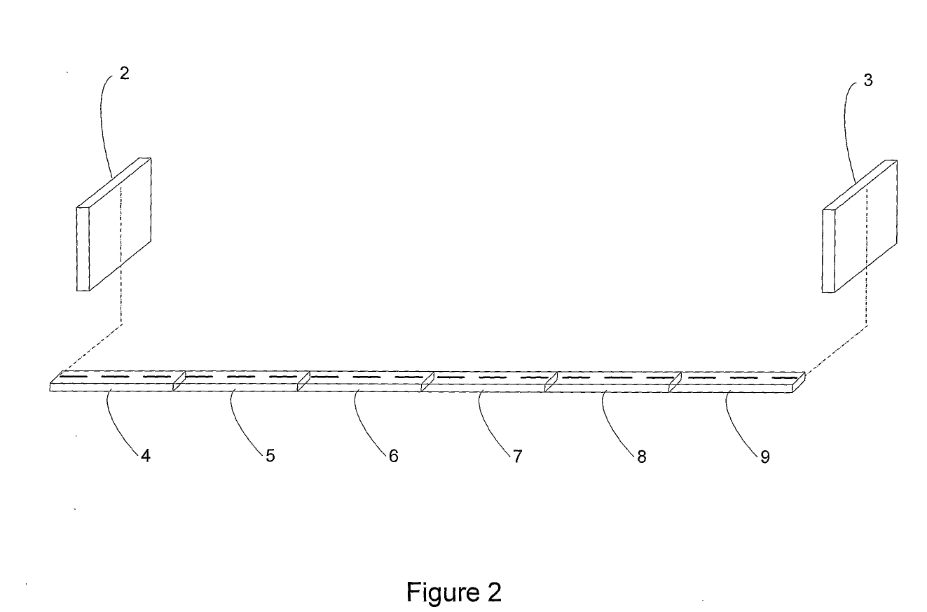

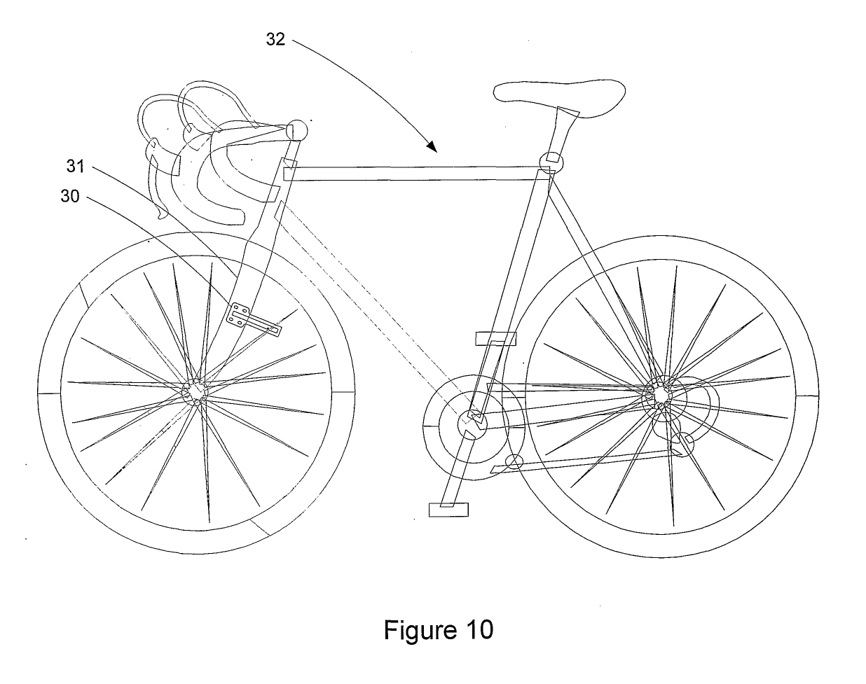

The sports timing system 1 provides an RF field which bikes and competitors pass through. RFID tags 30 (see FIG. 10) worn by competitors, or mounted on bicycles (or similar articles) receive energy from the RF field and produce a modulated backscatter RF signal that contains information as to the identity of the RFID tag. The receive antennas 2 and 3 detect the backscattered RF signal from the tag, which is transferred to the control, detection, and timing circuitry (shown in FIG. 1 as 10 and 11). Upon detection of the tag, timing information is generated, which may be temporarily stored within the control, detection, and timing circuitry 10, 11, but is forwarded to a computer or laptop 12 for permanent storage.

The sports timing system 1 is well suited to cycling and running, but may also be adapted for other race formats such as kayaking.

The sports timing system 1 may operate at ultra high frequencies in the 840 to 960 MHz range, so as to achieve a long reading distance.

The RFID tags 30 used in the sports timing system 1 may operate in the 840 to 960 MHz range and may be tuned to resonate at the same operating frequency as the RF elements of the control, detection, and timing circuitry 10, 11.

The RFID tags 30 may include notch, slot, monopole, dipole, patch, or other antennas. The preferred form is a notch so as to result in a physically small tag.

The RFID tags 30 may be passive, active, or battery assisted, i.e. the RFID transponder 33 in the tag receives power either from the RF field, or from a battery. The RFID tag 30 may also receive power from secondary RF field sources. The preferred form of the RFID tag 30 is a passive tag—powered only from the energy in the RF field(s) due to low cost of the tags and there being no need for an internal or external power supply.

The RFID transponder 33 is operatively coupled to the antenna 34 in the tag, and will modulate the backscatter from the tags antenna in a manner so as to encode a globally unique identification number into the backscattered RF signal. In an active tag, this signal may be amplified or generated from power supplied by a battery.

The RFID tag 30 is covered with a solid dielectric so as to maintain a consistent dielectric material in the very near vicinity of the tuned elements of the tag. This reduces the effect of water and other objects that may alter the tuning of the RFID tag 30, which would affect its performance. In the preferred form, the solid dielectric is at least 1 mm thick on all sides of the tag.

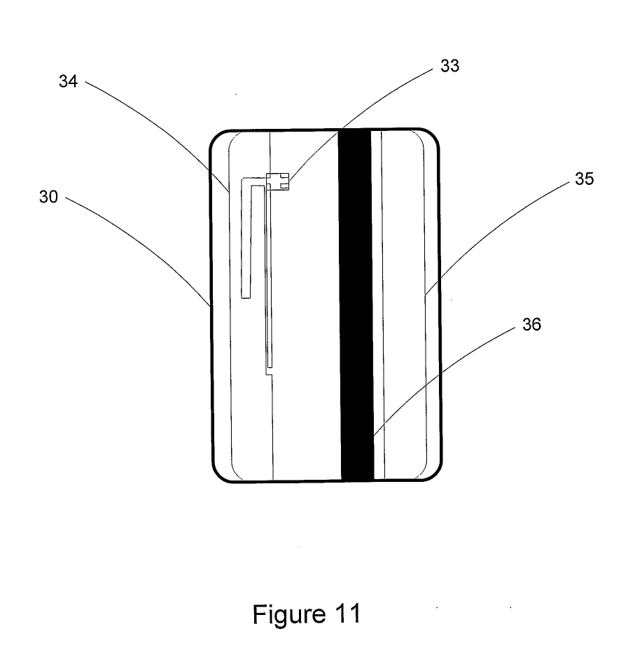

The RFID tag 30 may be packaged into a credit card format as shown in FIG. 11, so as to allow the card to be used for secondary purposes such as identifying the competitor to other agencies (e.g. for retail discounts at an event sponsor's retail outlets, or as a customer loyalty card). A tag in a credit card form may or may not have a magnetic stripe 36 for storing additional information on the card.

The RFID tag 30 may be mounted onto the bicycle 32, competitor or other object by any one of a multiplicity of means, such as (a) cable tying the tag directly to the object, (b) cable tying a tag holder to the object, and then separately mounting the tag into the holder, possibly using a click-in or spring-release system, or (c) integrating cable ties directly into the RFID tag. In the preferred form the tag holder is cable tied to the front fork 31 of the bicycle 32.

Due to the short period of time that the tag 30 is located in the RF field, it is required to transmit its identification number promptly, and to repeat its transmission periodically to provide the control, detection, and timing circuitry 10, 11 with a multiplicity of opportunities to detect the tag 30. At the same time, the tag 30 must not transmit its identification number too often or it will collide with transmissions from other tags and both will become unresolvable. These two factors must be traded off and combined with other system parameters (such as the RF switching period) and optimised for overall system performance.

For optimum performance, and the ability to read RFID tags 30 reliably in only a short period of time (and also with a multiplicity of RFID tags present at one time), it is important to select an RFID transducer 33 with a fast initial response, and that either does not require signals to be transmitted by the RFID reader (part of the control, detection, and timing circuitry 10, 11), or where the signals transmitted by the RFID reader do not stop or disrupt the backscattered signals from the tag 30 for any significant period of time. For these reasons RFID transducers 33 that use the iPX protocol are preferred.

The RFID transducer 33 may be selected as a read only transducer, or as a read/write transducer capable of storing additional information such as an expiry date or date of issue. The preferred form is a read only transducer.

Suitable storage software runs on the computer or laptop 12. This software performs a multiplicity of functions in the sports timing system 1.

Tag timing information that is generated by the control, detection, and timing circuitry 10, 11 is stored in a relational database that relates the tag identification number and the timestamp with the appropriate competitor and/or team, and with the appropriate event. All timestamps are recorded, representing the start, finish, and midpoints of an event. The software also aggregates, applies handicaps and adjustments, sorts, and publishes the results.

In the sports timing system 1, antennas are used for transmitting RF signals to the RFID tags, and for receiving the backscattered signals from the RFID tags.

The antennas used for transmitting and receiving RF signals may be separate antennas, or the same antennas may be used for transmitting and receiving. In the preferred form, separate antennas are used.

The transmit antenna is preferably an array of antennas mounted on the ground (4 through 9), with the RF field directed upwards in an elongate shape similar to a curtain 40. Having the antennas 4 through 9 mounted on the ground provides the shortest reasonable path from the antenna to the RFID tag 30 on the bicycle 32 or competitor, and also provides a path with minimised obstruction caused by neighbouring bicycles or competitors. This is particularly important for passive RFID tags 30 that obtain their power from the RF field. This also means that the RFID tags 30 will often be located in the near field of the antennas radiation pattern, which is susceptible to standing waves and nulls, particularly when the antenna is an array.

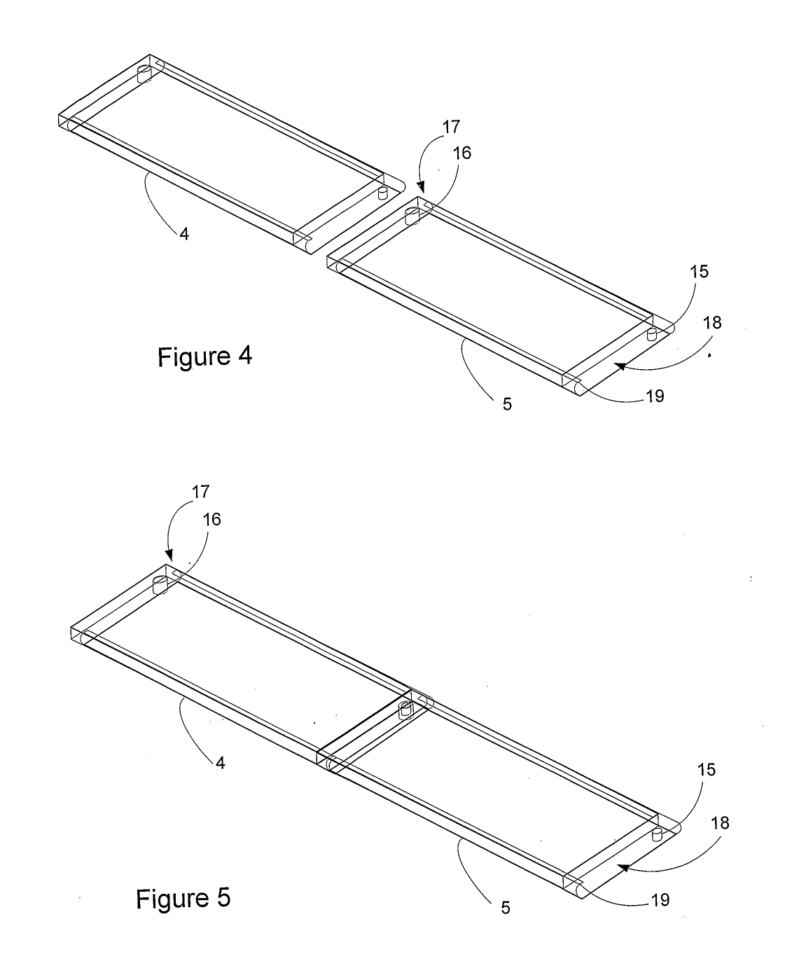

Preferably the ground mounted antennas 4 through 9 are placed exactly on the finish line or start line or midpoint so that the tag 30 is detected only in very close proximity to the start/finish line. Preferably the ground mounted antennas 4 through 9 are assembled from a multiplicity of separate panel antennas 4 through 9, with each panel measuring about 1200 mm×200 mm×8 mm. Preferably the ground transmit antennas 4 through 9 interlock in such a manner as to prevent them moving inadvertently when bicycles, runners, cars, or other vehicles pass over them (or at least to resist and diminish such antenna movement). One embodiment of an interlocking system is shown in FIGS. 4 and 5, where a metal frame around the antenna is extended at one end of the panel 18, and the panel extends beyond the metal frame at the other end 17. The panel extension 17 is inserted above the metal frame extension 18 and below a lip 19 on the frame, and the panel is lowered such that a spigot 15 is inserted into a receiving cavity 16 to prevent or minimise lateral movements between adjacent panel antennas. A second embodiment of an interlocking system is the use of hook and loop fasteners linking together the antenna covering mats, where the antennas are also firmly secured to/in the mat.

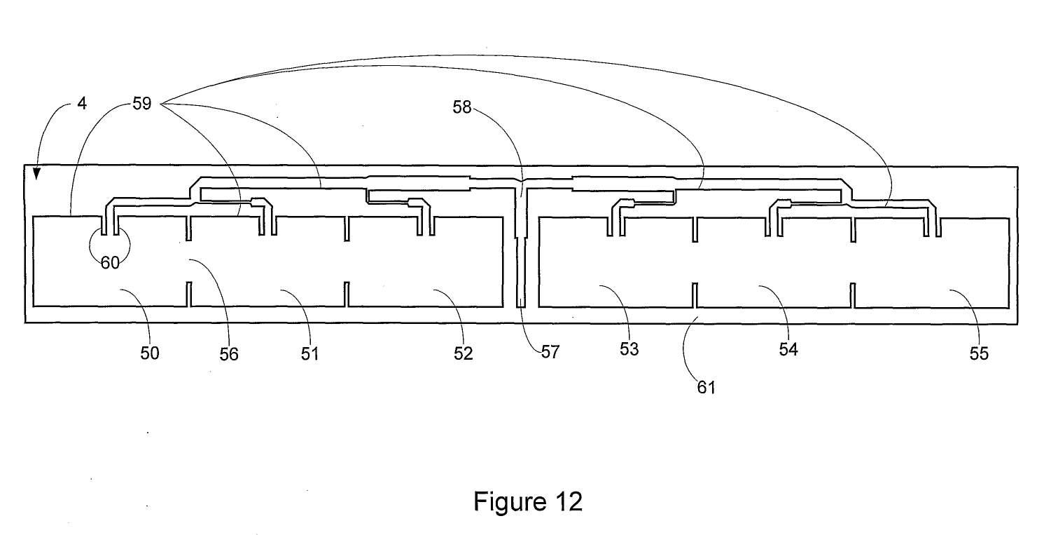

One embodiment of a ground mounted panel antenna 4 is shown in FIG. 12. It contains an array of patch antennas 50 through 55, that may be partially conjoined to produce a more consistent RF power distribution in the near field. The antenna is driven from a signal entry point 57 and the signal is distributed by a built in feed network 58. The feed network and patch antennas are formed by forming grooves 59 in a conductive sheet 61, with the grooves extending into the patch antennas to provide impedance matching as indicated by 60.

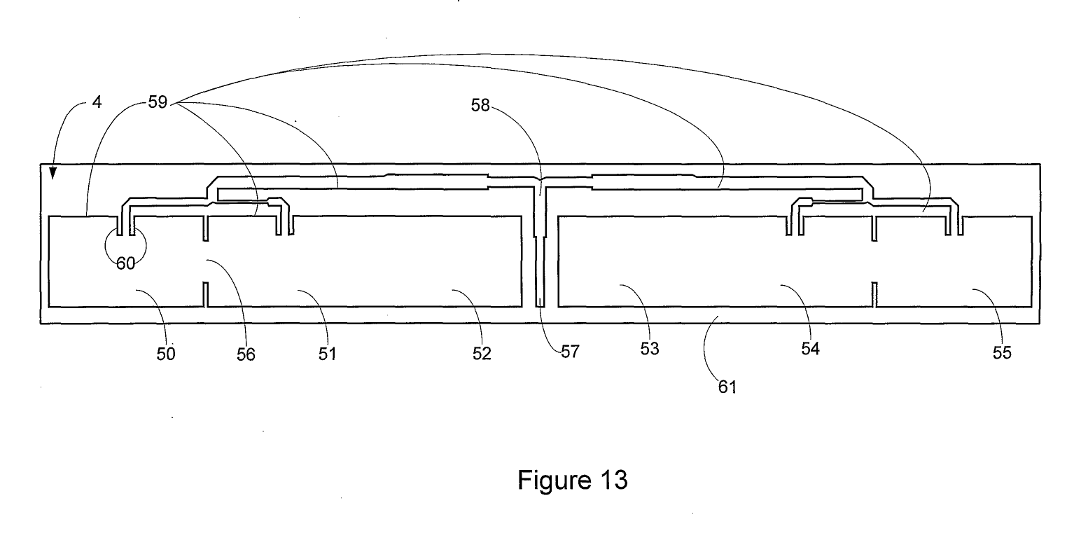

FIG. 13 shows a variant of the antenna shown in FIG. 12 in which patch antennas 51 and 52 and 53 and 54 are commonly fed.

The ground mounted antennas 4 through 9 are covered with a mat 20 so as to maintain a consistent dielectric material in the very near vicinity of the tuned elements 50 through 55 of the antenna. This reduces the effect of water and other objects that may alter the tuning of the antenna, which would affect its performance. In the preferred form, the mat 20 is at least 10 mm high. The mat 20 is shaped to allow a smooth passage over the antennas 4 through 9, so as to minimise disruption to cyclists or other wheeled vehicles, and also to physically protect cables 21 connecting the antennas to the control, detection, and timing circuitry 10, 11. The combined height of the antennas 4 through 9 and the mat 20 is minimised, with the combined height preferably being less than 20 mm above the ground, and more preferably less than 12 mm above the ground.

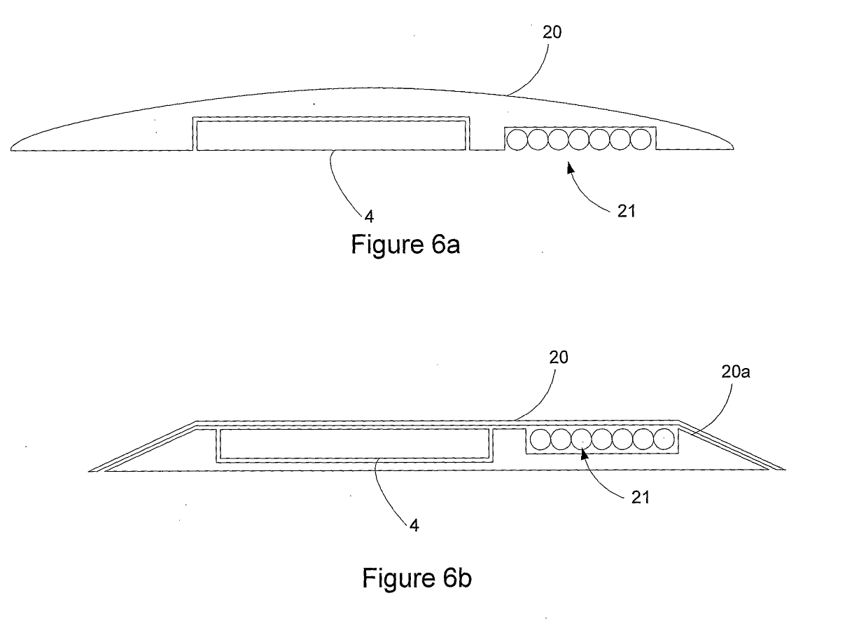

FIG. 6a shows a mat 20 including conduits to accommodate cables 21 and antennas 4. FIG. 6b shows an embodiment in which a base 20a has conduits in its top surface to accommodate conduits 21 and antennas 4 and a mat 20 is secured over the top.

The receive antennas 2, 3 may be mounted on the ground or on the side of the road or track. If the receive antennas 2, 3 are mounted on the ground then care must be taken to achieve sufficient isolation from the transmit antennas 4 through 9—particularly in an environment with lots of metallic objects such as bicycles 32 above the ground mounted transmit antennas 4 through 9. Preferably the receive antennas 2, 3 are mounted on the side of the road or track, slightly in front of, or behind, the transmit antenna 4 through 9. Preferably a receive antenna 2, 3 is mounted on each side of the road or track. It is also possible to use different numbers of receive antennas, such as 1, or 4, where the directionality, gain, and placement of each antenna is optimised such that the combination of antennas provides maximum likelihood of receiving a strong signal from the RFID tag, even in the presence of interfering objects such as people and bicycles.

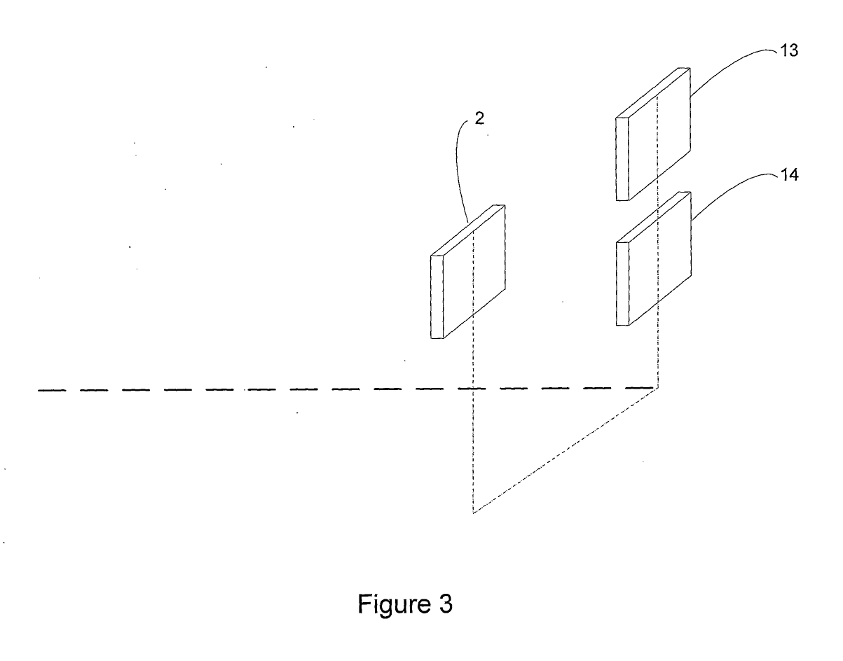

The transmit antennas may optionally be mounted on the side of the road or track instead of on the ground, as shown by 13, 14 in FIG. 3. The preferred form is to mount the transmit antennas on the ground.

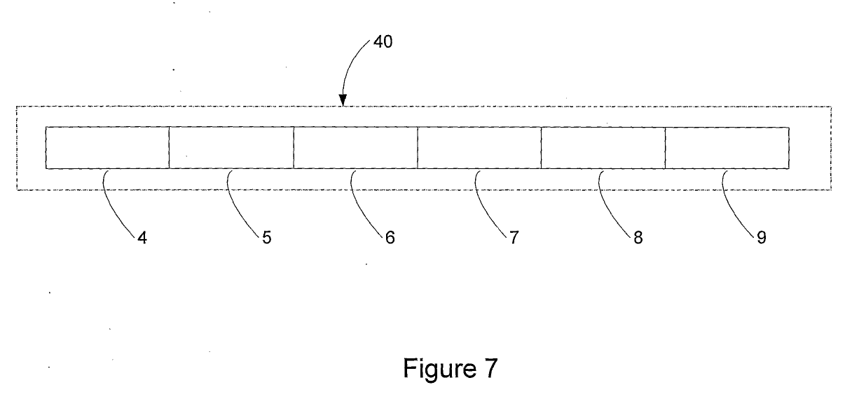

The shape of the transmitted RF field is important as variations in the uniformity of the shape introduce positional or timing errors in the detection of the RFID tags 30. Ideally the transmitted RF field is in the shape of a curtain 40, that the cyclists or competitors pass through as shown in plan view in FIG. 7. Ideally this RF curtain 40 has a uniform thickness that is sufficiently thick that RFID tags 30 spend enough time inside the curtain to allow the tags to reliably detected. Ideally the front edge of the RF curtain 40 is completely straight. Preferably the RF curtain 40 is between 300 mm and 1000 mm thick.

The shape of the transmitted RF field is also designed to minimise the variation in the strength of the upwardly projected RF field. This is to maintain a consistent RF field strength that is close to the regulatory limit, over the entire length of the antenna array 4 through 9.

A curtain like RF field 40 is created by having a linear array of vertically directly radiating antenna elements mounted on the ground. To achieve consistency in the RF field (in front to back curtain thickness, and the power level directed upwards), the ground mounted antennas 4 through 9 are composed of many closely spaced radiating elements 50 through 55.

For applications where the orientation of the RFID tag 30 is largely fixed, such as cycling and motor sport, the preferred form is for an RF field that is linearly polarised in the direction of the polarisation of the RFID tag 30.

For applications where the orientation of the RFID tag 30 is largely free to change, such as running and walking (e.g. by runners rotating their bodies and waving to a crowd as they cross a finish line), the preferred form is for an RF field that is circularly polarised.

The internal consistency of the RF field is a necessary consideration to prevent the occurrence of regions of zero signal (or signal power levels that are attenuated to be below the tag's operating threshold). Such regions may occur from standing waves produced by multiple antenna elements in an array, and also from operating in the very near field of an antenna's radiation pattern.

To alleviate the problem of reduced signal regions caused by standing waves, a selection of elements in the antenna array are subjected to changes in the driving signal. Preferably at least every second element is subjected to changes, so that its driving signal is different to that of the elements immediately adjacent to it, since adjacent elements will have the strongest interference, and changing the driving signal to one or both of them will prevent the occurrence of a steady state standing wave.

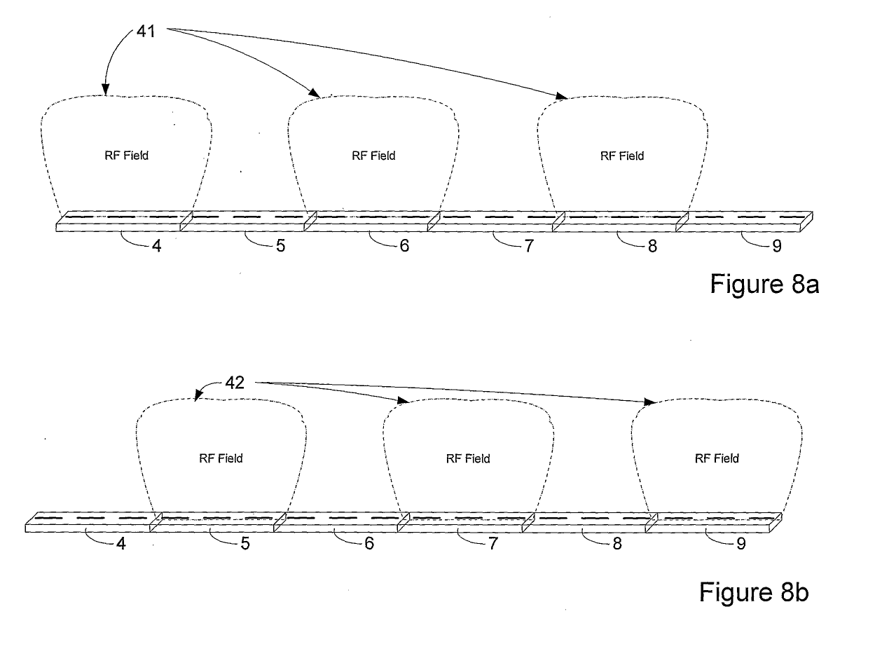

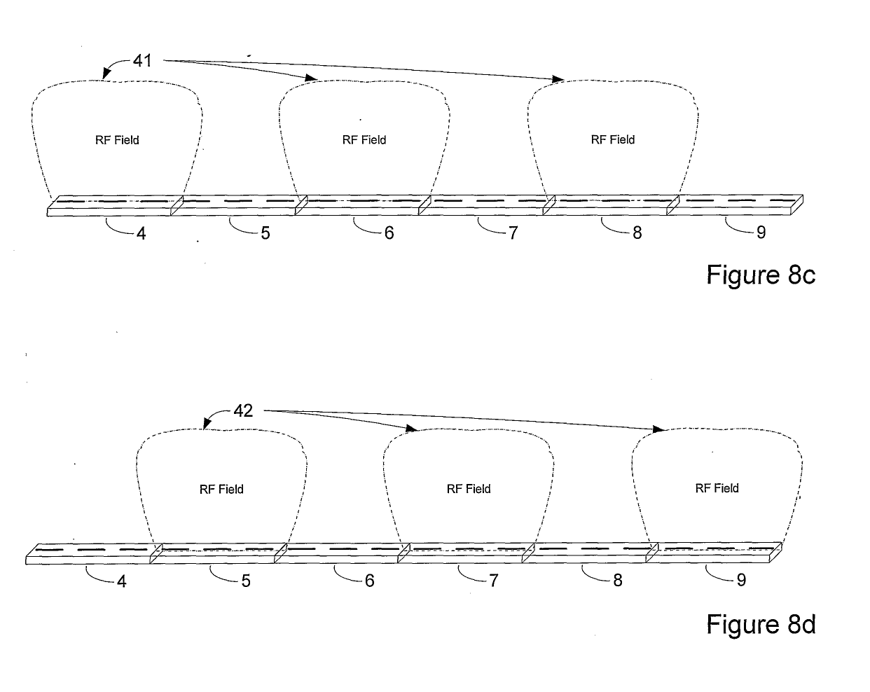

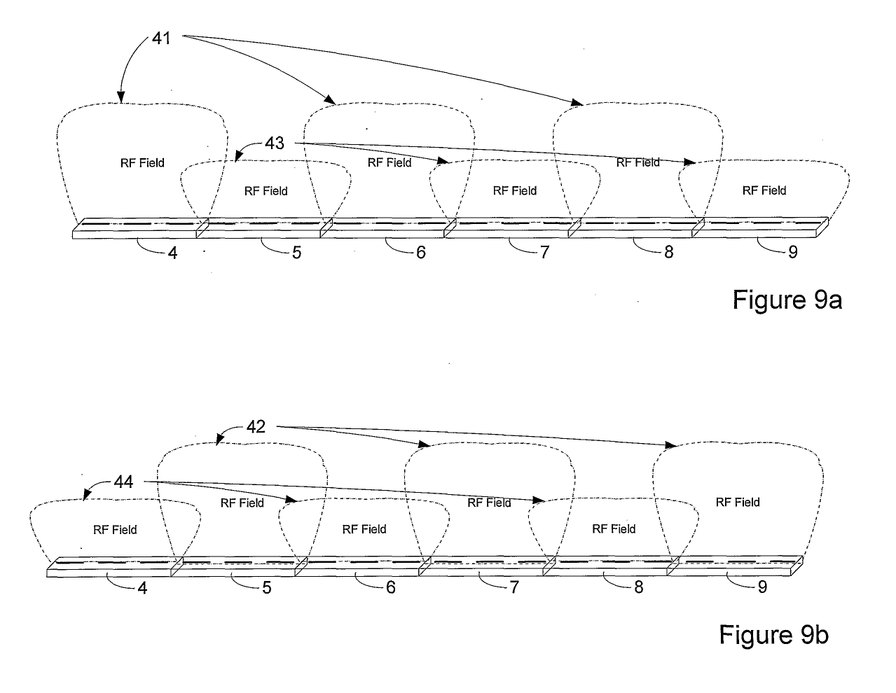

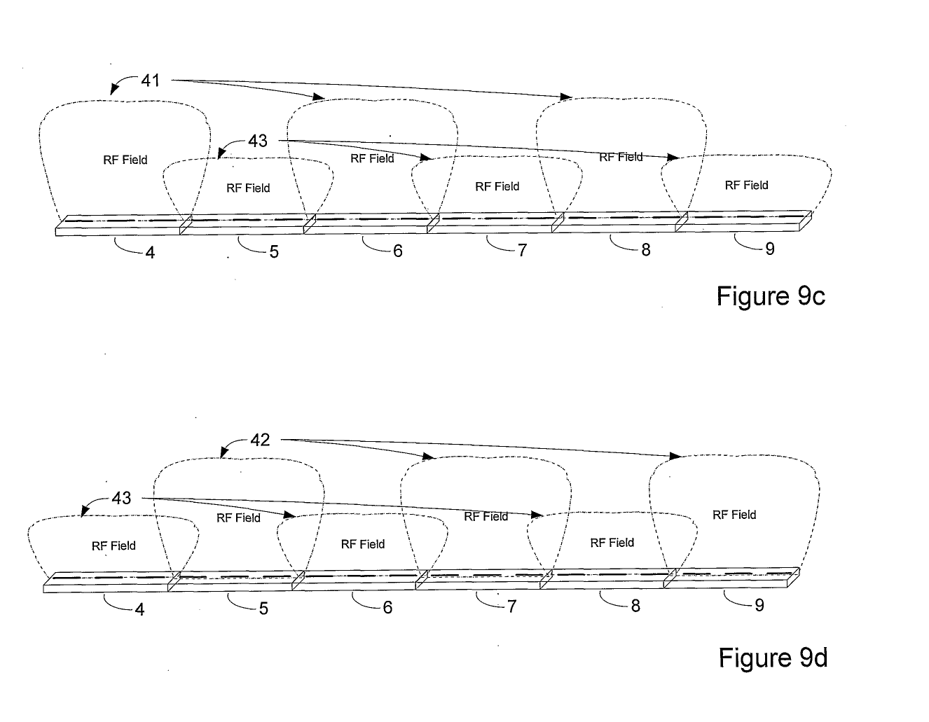

The changes in the driving signal may be constructed as amplitude, frequency or phase alterations. The alterations may be digital or analogue in nature (i.e. the alterations may be stepped, or may vary continuously). Alterations in the driving signal may be applied to a selection of antenna elements, or to all antenna elements but in different pattens such as in anti-phase. The rate and magnitude of the alterations may also be configurable. For example amplitude alterations may involve turning some radiating elements completely off for a period of time, as shown in the sequence of FIGS. 8a to 8d as 41 and 42, or in may involve partially attenuating the signal driving some elements, as shown in the sequence of FIGS. 9a to 9d as 41, 42, 43 and 44. Similar adjustments to signal phase or frequency may be made.

The period of the alterations in the driving signal is configurable and is preferably between 5 and 60 milliseconds. Preferably the driving signal alters with a period of 30 milliseconds or less for very fast moving cyclists or competitors, and alters with a period of 60 milliseconds or more for large groups of slow moving cyclists or competitors.

The control, detection, and timing circuitry 10, 11 provides the appropriate multiplicity of signals (such as 41 through 44) to drive the radiating elements of the transmit antenna 4 through 9. It also processes the signals received by the receive antenna 2, 3 and interprets these signals to obtain the tag identification numbers. Upon identification of a tag 30, a timestamp is associated with the tag, and this timestamp together with the tag identification number is stored within the local storage capability of the control, detection, and timing circuitry 10, 11, and the same data is then forwarded, to the connected computer or laptop 12. In the event that no computer or laptop 12 is connected, the data can be retrieved at a later time.

Optionally, the storage capability of the control, detection, and timing circuitry 10, 11 may be omitted. Preferably the storage capability is included.

Additional communications links may be inserted into the system between the control, detection, and timing circuitry 10, 11 and the computer or laptop 12.

The sports timing system 1 has the following advantages over systems of the prior art:
It is significantly more accurate than lower frequency (HF) systems that use large ground loop antennas
It supports significantly faster moving objects than lower frequency (HF) systems.
It is significantly lower cost than active systems.
It is easy to deploy, as it requires no infrastructure such as overhead gantries, which are required by some other timing systems.
It handles congestion of cyclists or competitors within the timing regions. It successfully alleviates issues of obstruction of RF signals by other cyclists or competitors.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1-30. (canceled)

31. A timing system comprising:
a. a radio frequency signal source;
b. a transmitting antenna array driven by the radio frequency signal source configured to illuminate an elongate timing region with portions of the array driven with modulated intensity;
c. a receiving antenna for receiving signals generated by RFID transponders illuminated by the transmission antenna; and
d. a timing circuit which generates timing information based on the signals received by the receiving antenna.

32. A timing system as claimed in claim 31 wherein the transmitting antenna is an array of low profile panel antennas.

33. A timing system as claimed in claim 32 wherein the panel antennas include arrays of patch antennas.

34. A timing system as claimed in claim 32 wherein the panel antennas are about 1 cm thick.

35. A timing system as claimed in claim 32 wherein the panel antennas are mounted on the ground.

36. A timing system as claimed in claim 35 wherein the panel antennas are covered by a waterproof mat.

37. A timing system as claimed in claim 32 wherein couplings are provided at the ends of the panel antennas enabling adjacent panel antennas to be joined together.

38. A timing system as claimed in claim 31 wherein alternating portions of the antenna array are alternately driven and not driven.

39. A timing system as claimed in claim 31 wherein portions of the antenna array are driven in such a way that any two adjacent radiating elements will not maintain a consistent standing wave between them.

40. A timing system as claimed in claim 31 wherein the transmitting antenna is mounted to a side of the antenna array.

41. A timing system as claimed in claim 31 wherein different portions of the antenna array are driven with different RF signals with variable phase angles between the signals.

42. A timing system as claimed in claim 31 wherein the timing circuit stores the identity of each RFID tag detected along with a timestamp as to the time of receipt.

43. A timing system as claimed in claim 31 including an RFID tag secured to a thing to be timed.

44. A timing system as claimed in claim 43 wherein the RFID tag is in the form of a credit card.

45. A timing system as claimed in claim 44 wherein the RFID tag includes a magnetic stripe.

46. A timing system as claimed in claim 43 wherein the RFID tag includes a notch antenna.

47. A timing system as claimed in claim 31 wherein the RFID system is operating at a UHF frequency.

48. A timing system as claimed in claim 31 wherein the system is supplemented with one or more radio frequency signal sources, and one or more transmitting antenna driven by the radio frequency signal sources.

49. A method of timing articles passing through an elongate timing region comprising:
e. securing an RFID tag with a unique identifier to each article;
f. illuminating the timing region with a first beam such that different portions of the timing region are illuminated at different times;
g. receiving signals transmitted from the RFID tags as they pass through the timing region; and
h. associating timing information with each RFID tag identifier based on the received signals.

50. A method as claimed in claim 49 wherein the timing region is in the form of a curtain across a timing point on a track.

51. A method as claimed in claim 49 wherein an array of panel antennas are positioned across the timing region to illuminate the timing region from the ground.

52. A method as claimed in 51 wherein different regions of the panel antennas are driven at different times.

53. A method as claimed in 52 wherein the panel antennas include a plurality of patch antennas.

54. A method as claimed in any one of claims 49 wherein when a signal is received from an RFID tag the identification number of the RFID tag is time stamped and stored.

55. A method as claimed in claim 54 wherein each identification number is associated with a competitor and the performance of the competitor is determined based on timing information.
